(19) United States
(12) Patent Application Publication
(10) Pub. No.: US 2003/0014278 A1
(43) Pub. Date: Jan. 16, 2003

(54) Method for managing personal information in a mobile communication system

(75) Inventors: Jong-Il Park, Seoul (KR); Kyung-Hoon Kim, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/192,635

(22) Filed: Jul. 11, 2002

(30) Foreign Application Priority Data
Jul. 13, 2001 (KR) 42396/2001

(51) Int. Cl. G06F 17/60

(52) U.S. Cl. 705/1

(57) ABSTRACT

A method for managing personal information is provided that uses a mobile communication system capable of supporting short message service (SMS) and including a plurality of mobile terminals having a Personal Information Management (PIM) function. The method edits and transmits PIM data through a terminal and receives and manages the PIM data. Since a record (PIM data) of a PIM database is transmitted or received as a single entity, it is not necessary to enter the PIM data character by character and to input the text message to the PIM database character by character to transmit the data. Therefore, editing and managing of the PIM data can be done easily and swiftly.

### BACKGROUND OF THE INVENTION

1. Field of the Invention

The invention relates to a mobile communication system and more particularly, to a method for managing personal information in a mobile communication system.

2. Background of the Related Art

In conventional mobile communication systems, PIM data to be transferred from one mobile terminal to another is displayed first on a display of the former and then is then inputted into the latter using a keypad character. Alternatively, the PIM data is uploaded from the former to a personal computer (PC) and is then downloaded to the latter if the mobile terminals have a PC-SYNC function.

When it is required to send a remote mobile terminal user the PIM data stored in a PIM database, the data is transferred in voice format or is transmitted in the form of a text message after being rewritten with a keypad in a short message service (SMS) mode. In the case that the data is received in the form of a voice or a text message and the data is to be stored in a PIM database of the receiving mobile terminal, the mobile terminal should first enter a PIM mode so as to store the data in the form of PIM data input with the keypad.

That is, in the case of transmitting the PIM data in the SMS mode, the PIM data is transmitted in the form of a text message as inputted by the user such that it is difficult to edit and transmit several PIM data to multiple mobile terminals at the same time, even though the SMS is useful when transmitting a few PIM data to one mobile terminal. It is also inconvenient to edit the received text message and store it as the PIM data in the PIM database.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

It is an object of the invention to provide a method for managing personal information in a mobile communication system, capable of transmitting data stored in a PIM database of a mobile terminal in the form of a table record of the PIM database.

To achieve at least these and other objects in whole or in part and in accordance with the purposes of the invention, as embodied and broadly described, there is provided a method for managing personal information using a mobile communication system according to an embodiment of the invention, including the steps of editing and transmitting PIM data through a terminal and receiving and managing the PIM data.

The PIM data editing and transmitting step according to an embodiment of the invention may include entering a PIM data transmission mode, retrieving a target PIM data, and transmitting the retrieved PIM data.

The target PIM data retrieving step according to an embodiment of the invention may include displaying table items of a PIM database on a display of the mobile terminal, selecting one of the displayed table items, displaying a data retrieval screen for a table corresponding to the selected table item, retrieving the target PIM data in the table corresponding to the selected table item on the basis of a keyword received through a keypad, determining whether or not the target PIM data exists in the table corresponding to the selected table item, and displaying the target PIM data on a display if the target PIM data exists. The target PIM data retrieving step according to an embodiment of the invention may further include displaying a message indicating that the target data does not exist in the table if it is determined that the target data does not exist in the table and then returning to the step of displaying the data retrieval screen.

The PIM data transmitting step according to an embodiment of the invention may include determining whether or not the PIM data needs to be edited, editing the PIM data if the PIM data needs to be edited, temporarily storing the edited PIM data in a memory, inputting at least one phone number of a remote terminal to receive the PIM data, and transmitting the PIM data to the remote terminal. The target PIM data retrieving step according to an embodiment of the invention may further include storing the PIM data in the memory without editing if the data does not need to be edited.

The PIM data receiving and managing step according to an embodiment of the invention may include receiving a SMS message, determining whether or not the SMS message contains PIM data, and dividing the PIM data into fields and storing the PIM data in a unit of a field if the SMS message contains PIM data. If the SMS message does not contain PIM data, a normal text-processing routine is performed.

The PIM data receiving and managing step according to an embodiment of the invention may further include editing the PIM data before storing the same in the table.

According to another embodiment of the invention, a method for managing personal information in a mobile communication system supporting short message service (SMS) and including a plurality of mobile terminals having a Personal Information Management (PIM) function, comprises entering a PIM data transmission mode, retrieving a target PIM data, transmitting the retrieved PIM data, and receiving and managing the PIM data.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. The invention will be described in detail with reference to the following drawings in which like reference numerals refer to like elements wherein:

FIG. 1 is a drawing illustrating a message format applied to a method for managing personal information in a mobile communication system in accordance with an embodiment of the invention;

FIG. 2 is a flow chart that illustrates a PIM data transmission process in a method for managing personal information in accordance with an embodiment of the invention; and

FIG. 3 is a flow chart that illustrates a PIM data-receiving process in a method for managing personal information in accordance with an embodiment of the invention.

### DETAILED DESCRIPTION OF PREFERRED EMBODIMENTS

Reference will now be made in detail to embodiments of the invention, examples of which are illustrated in the accompanying drawings.

To perform the method for managing personal information in accordance with embodiments of the invention, a text transmission mode and PIM data transmission mode items are provided in the sub menu of a SMS mode of a mobile terminal. Therefore, in the case of transmitting the data stored in the PIM database, the user edits a certain PIM data (table record) of the PIM database in the PIM data transmission mode and transmits the edited PIM data to other mobile terminals.

Even though there can be many different kinds of tables in a PIM database of the mobile terminal, a telephone number management table will be described as an example.

Generally, the telephone number management table in a PIM database includes a plurality of records, each having fields of, for example, name, phone number, e-mail, address, occupation, and the like, and the PIM data is transmitted in a unit of record. The PIM data is distinguished from the text data by an identifier of the SMS message and the respective fields of the PIM data are divided by the delimiters.

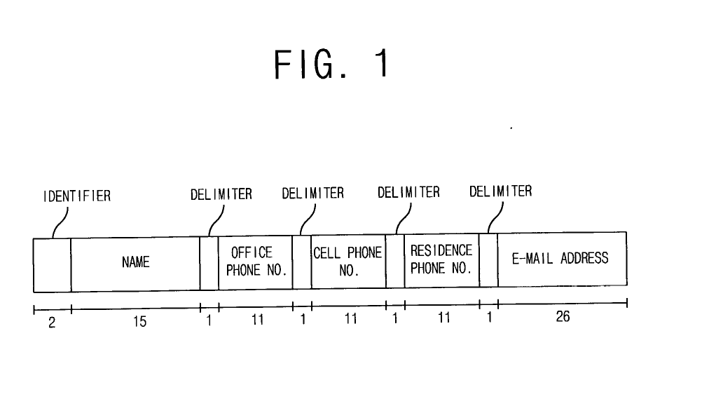

FIG. 1 is a drawing illustrating a message format applied to a method for managing personal information in accordance with an embodiment of the invention. As shown in FIG. 1, a PIM data file has a length of 80 bytes and includes, in order, an identifier of 2 bytes, a name field of 15 bytes, a delimiter of 1 byte, an office phone number field of 11 bytes, a delimiter of 1 byte, a cellular phone number field of 11 bytes, a delimiter of 1 byte, a residence phone number field of 11 bytes, a delimiter of 1 byte, and an e-mail address field of 26 bytes.

When receiving a SMS message, the mobile terminal determines whether the currently received data is text data or PIM data on the basis of the identifier. If the data is PIM data, the mobile terminal parses the PIM data and stores it in the telephone number management table of the PIM database after dividing the PIM data into respective fields on the basis of the delimiters.

The length of the PIM data file is not limited to 80 bytes and can be changed according to the number of the fields comprising a PIM data file and the sizes of the respective fields. Of course, the PIM data transmission can be performed between terminals having the PIM mode data transmission function. It is also possible to communicate the PIM data with terminals in other communication systems by standardization of the PIM database.

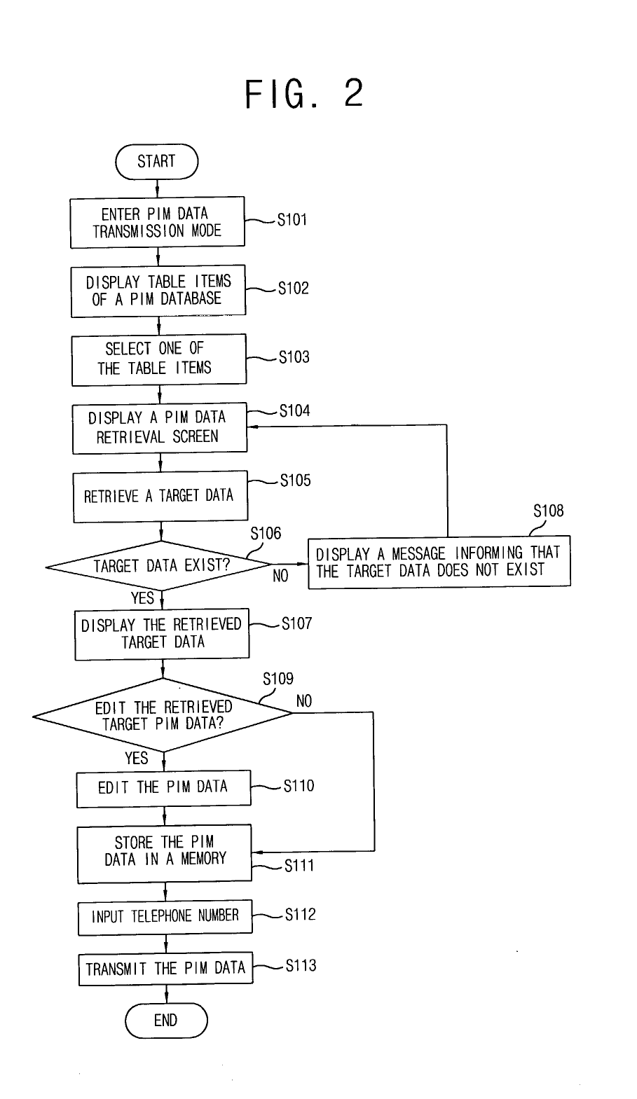

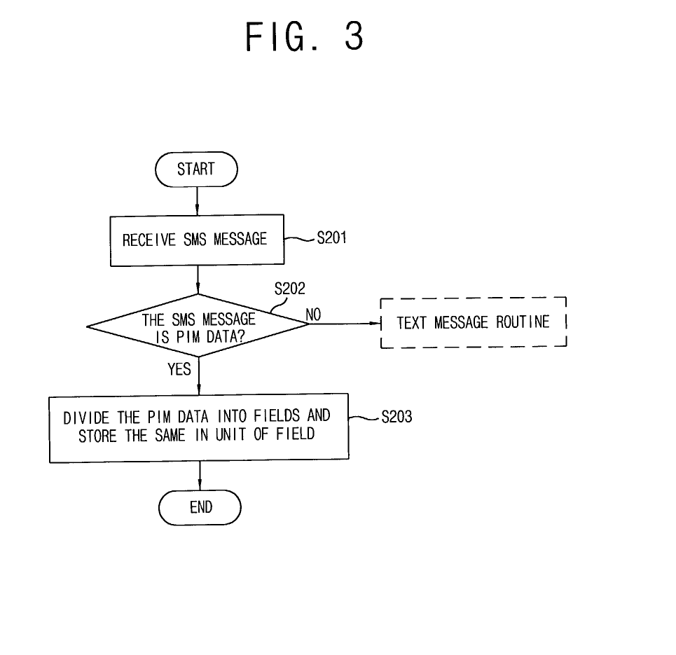

Hereinafter, the method for managing personal information in a mobile communication system in accordance with an embodiment of the invention will be described in detail with reference to FIG. 2 and FIG. 3.

FIG. 2 is a flow chart showing a process for transmitting PIM data in a method for managing personal information in a mobile communication system according to an embodiment of the invention. As shown in FIG. 2, when a PIM data transmission mode is selected at step S101 in the sub menu of a SMS mode of a mobile terminal for transmitting the PIM data, the mobile terminal displays table items of a PIM database at step S102. If the phone number management table is selected among the items at step S103, the mobile terminal displays a data retrieval screen for retrieving a target PIM data in the phone number management table at step S104, receives a keyword for retrieving target PIM data through the keypad at step S105, and determines whether or not the target PIM data exists in the phone number management table at step S106. If the target data does not exist in the table, a message is displayed on the display indicating that the target data does not exist at step S108 and the process returns to the retrieval screen again. Alternately, the target data is displayed on the display of the terminal at step S107 if the target data exists in the table.

If the target data exists, the mobile terminal determines whether or not the target data should be edited according to a user's intentions at step S109. The PIM data is then edited by keypad manipulation at step S110 and the edited PIM data is temporarily stored in the memory at step S111. If there is no need to edit the data, the PIM data is stored in the memory as is, at step S111.

Next, the terminal receives at least one phone number of another terminal in order to receive the PIM data at step S112, and transmits the PIM data to the mobile terminal having the phone number at step S113. By inputting more than one phone number, PIM data can be transmitted to a plurality of mobile terminals at the same time.

FIG. 3 is a flow chart for illustrating a PIM data-receiving process in a method for managing personal information according to an embodiment of the invention.

When a SMS message is received at step S201, the mobile terminal determines whether the received message is a text data or PIM data on the basis of an identifier at step S202. If it is determined that the received SMS message is PIM data, the PIM data is deleted or stored in the phone number management table of the PIM database in a unit of a field according to the user's intention at step S203. If the received message is not the PIM data, the message is processed as a text message.

As described above, in a method for managing personal information according to embodiments the invention, since a record (PIM data) of a PIM database is transmitted and received as a single object, it is not required that the PIM data be rewritten in text form for SMS transmission, or that the PIM data received in the form of text data be PIM data to be stored in a PIM database. That is, the PIM data is transmitted and received as a record of the PIM database, such that the received PIM data can be stored in the PIM database as is, without further processing, resulting in enhancement of PIM data management.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for managing personal information in a mobile communication system supporting short message service (SMS) and including a plurality of mobile terminals having a Personal Information Management (PIM) function, comprising:
editing and transmitting PIM data using a terminal; and
receiving and managing the PIM data.

2. The method of claim 1, wherein the PIM data editing and transmitting step comprises:
selecting a PIM data transmission mode;
retrieving from a PIM database a target PIM data for transmission; and
transmitting the retrieved PIM data.

3. The method of claim 2, wherein the target PIM data retrieving step comprises:
displaying table items of a PIM database on a display of the mobile terminal;
selecting at least one of the displayed table items;
displaying a data retrieval screen for a table corresponding to the selected table item;
retrieving the target PIM data in the table corresponding to the selected table item on the basis of a keyword input through a keypad;
determining whether or not the target PIM data exists in the table corresponding to the selected table item; and
displaying the target PIM data on a display if the target PIM data exists.

4. The method of claim 3, wherein the target PIM data retrieving step further includes displaying a message indicating that the target data does not exist in the table if it is determined that the target data does not exist in the table and then returning to the step of displaying the data retrieval screen.

5. The method of claim 2, wherein transmitting the PIM data comprises:
determining whether or not the PIM data needs to be edited;
editing the PIM data if the PIM data needs to be edited;
temporarily storing the edited PIM data in a memory;
inputting at least one phone number of a remote terminal to receive the PIM data; and
transmitting the PIM data to the remote terminal.

6. The method of claim 5, wherein the target PIM data retrieving step further comprises storing the PIM data in the memory without editing if the data does not need to be edited.

7. The method of claim 1, wherein the step of editing and transmitting the PIM data comprises:
entering a PIM data transmission mode;
displaying table items of a PIM database;
selecting at least one of the displayed table items;
displaying a data retrieval screen for a table corresponding to the selected table item;
retrieving the target PIM data in the table corresponding to the selected table on the basis of a keyword received through a keypad;
determining whether or not the target PIM data exist in the table corresponding to the selected table item;
displaying the target PIM data on a display if the target PIM data exists; and
transmitting the retrieved PIM data.

8. The method of claim 7, wherein the target PIM data retrieving step further comprises displaying a message that the target data does not exist in the table if it is determined that the target data does not exist in the table and then returning to the step of displaying the data retrieval screen.

9. The method of claim 1, wherein the step of editing and transmitting the PIM data comprises:
selecting a PIM data transmission mode;
retrieving from a PIM database a target PIM data for transmission;
determining whether the PIM data needs to be edited, if the target PIM data exists;
editing the PIM data if the PIM data needs to be edited;
temporarily storing the edited PIM data in a memory;
inputting at least one phone number of a remote terminal to receive the stored PIM data; and
transmitting the PIM data to the remote terminal.

10. The method of claim 1, wherein the step of editing and transmitting the PIM data comprises:
selecting entering a PIM data transmission mode;
displaying table items of a PIM database;
selecting at least one of the displayed table items;
displaying a data retrieval screen for a table corresponding to the selected table item;
retrieving a target PIM data in the table corresponding to the selected table item on the basis of a keyword received through a keypad;
determining whether or not the target PIM data exists in the table corresponding to the selected table;
displaying the target PIM data on a display if the target PIM data exists;
determining whether or not the PIM data needs to be edited;
editing the PIM data if the PIM data needs to be edited;
temporarily storing the edited PIM data in a memory;
inputting at least one phone number of a remote terminal to receive the stored data; and
transmitting the PIM data to the remote terminal.

11. The method of claim 1, wherein the step of receiving and managing the PIM data comprises:
receiving a SMS message;
determining whether or not the SMS message contains PIM data; and
dividing the PIM data into fields and storing the PIM data in a unit of a field if the SMS message contains PIM data.

12. The method of claim 11, wherein a normal text-processing routine is performed if the SMS message does not contain PIM data.

13. The method of claim 1, wherein the step of receiving and managing the PIM data further comprises editing the PIM data before storing the same in a table.

14. A method for managing personal information in a mobile communication system, supporting short message service (SMS) and including a plurality of mobile terminals having a Personal Information Management (PIM) function, comprising:
selecting a PIM data transmission mode;
retrieving from a PIM database a target PIM data for transmission;
transmitting the retrieved PIM data; and
receiving and managing the PIM data.

15. The method of claim 14, wherein the step of receiving and managing the PIM data further comprises:
receiving a SMS message;
determining whether or not the SMS message contains PIM data;
dividing the PIM data into fields and storing the PIM data in a unit of a field if the SMS message contains PIM data.

16. The method of claim 15, wherein a normal text-processing routine is performed if the SMS message does not contain PIM data.

17. The method of claim 16, wherein the step of retrieving the target PIM data comprises:
displaying table items of a PIM database;
selecting at least one of the displayed table items;
displaying the data retrieval screen of the selected table;
retrieving the target PIM data on the basis of a keyword inputted through a keypad;
determining whether or not the target PIM data exists in the selected table; and
displaying the target data on a display if the target PIM data exists.

18. The method of claim 17, wherein the target PIM data retrieving step further comprises displaying a message that the target data does not exist in the table if it is determined that the target data does not exist in the table and then returning to the step of displaying the data retrieval screen.

19. The method of claim 18, wherein the step of transmitting the PIM data comprises:
determining whether or not the PIM data needs to be edited;
editing the PIM data if the data needs to be edited;
temporarily storing the edited PIM data in a memory;
inputting at least a phone number of a remote terminal to receive the PIM data; and
transmitting the PIM data to the remote terminal.

20. The method of claim 19, wherein the target PIM data retrieving step further comprises storing the PIM data in the memory without editing if the data does not need to be edited.
